(19) United States
(12) Patent Application Publication
(10) Pub. No.: US 2025/0074513 A1
(43) Pub. Date: Mar. 6, 2025

(54) BODY COMPONENT

(71) Applicant: FUTABA INDUSTRIAL CO., LTD., Okazaki-shi (JP)

(72) Inventors: Yuya Miyanaga, Okazaki-shi (JP); Miki Kotani, Okazaki-shi (JP)

(21) Appl. No.: 18/796,689

(22) Filed: Aug. 7, 2024

(30) Foreign Application Priority Data
Aug. 28, 2023 (JP) 2023-138297

(51) Int. Cl. B62D 25/06; B62D 25/04

(52) U.S. Cl. CPC B62D 25/06; B62D 25/04

(57) ABSTRACT

A body component for a vehicle is provided. The body component for a vehicle includes an annular portion having a hollow portion and being formed in an annular shape in a cross section orthogonal to a longitudinal direction of the body component. The hollow portion is set so that a neutral axis of an expected bending direction of the body component passes through the hollow portion in the cross section. The annular portion includes passing portions that the neutral axis passes through and that are located so as to face each other across the hollow portion, and distancing portions that are distanced from the neutral axis and that are located so as to face each other across the hollow portion. Each of the distancing portions includes a thickened portion that is thicker than the passing portions.

### CROSS-REFERENCE TO RELATED APPLICATIONS

This application claims the benefit of Japanese Patent Application No. 2023-138297 filed on Aug. 28, 2023 with the Japan Patent Office, wherein the entire disclosure of such application is hereby incorporated by reference herein.

### BACKGROUND

The present disclosure relates to a body component for a vehicle.

For example, Japanese Unexamined Patent Application Publication No. 2017-030676 discloses a body component formed through aluminum extrusion molding and having a column shape with a hollow portion in its cross section. The body component is formed so that one side of the body component with respect to a neutral axis in the cross section is thicker than the other side.

### SUMMARY

In recent years, weight reduction and safety improvement are required in vehicles. In particular, in the event of a small overlap crash of a vehicle, a large bending moment acts on a frame of the vehicle, and thus a body component for a vehicle is required to have a structure capable of withstanding the bending moment.

One aspect of the present disclosure is to allow weight reduction in a body component for a vehicle while ensuring that the body component has a sufficient strength against the bending moment.

One mode of the present disclosure is a body component for a vehicle. The body component comprises an annular portion including a hollow portion and formed in an annular shape. The hollow portion is formed in a cross section orthogonal to a longitudinal direction of the body component. The hollow portion is set so that a neutral axis of an expected bending direction of the body component passes through the hollow portion in the cross section. The annular portion comprises passing portions through which the neutral axis passes and that are located so as to face each other across the hollow portion; and distancing portions that are distanced from the neutral axis and are located so as to face each other across the hollow portion. Each of the distancing portions comprises a thickened portion that is thicker than the passing portions.

According to such a configuration, thickened portions are disposed in a part of the body component where a stress generated against the expected bending direction acts on more strongly, and portions of the body component in the vicinity of the neutral axis where the stress is less likely to act on are formed relatively thin. This enables the body component to withstand the stress and to be lightweight.

In one mode of the present disclosure, the annular portion may be formed in a seamless and integrated manner in the cross section.

According to such a configuration, the annular portion has a seamless structure, which can make the body component withstand a large impact more easily than in a case where the annular portion has a structure with seams. The seamless cross sectional structure can be formed through, for example, aluminum extrusion molding.

In one mode of the present disclosure, the body component may further comprise at least one fixing portion that is configured to be fixed to a member of the vehicle other than the body component. The at least one fixing portion may be seamlessly integrated with the annular portion.

According to such a configuration, the annular portion is integrated with the at least one fixing portion, and thus it is possible to reduce the number of parts of the body component further than in a case where the annular portion and the at least one fixing portion are formed separately from each other.

In one mode of the present disclosure, the body component may be disposed so as to form at least a part of a front pillar and a roof side rail of the vehicle so that the longitudinal direction of the body component extends along a front-rear direction of the vehicle. Also, the body component may be formed in a seamless and integrated manner so as to have an identical shape in the cross section at any position in the longitudinal direction.

According to such a configuration, the body component forms at least a part of the front pillar and the roof side rail in a seamless and integrated manner, and thus it is possible to improve rigidity of the body of the vehicle.

In one mode of the present disclosure, the body component may be made of a material containing aluminum as a main component.

According to such a configuration, it is possible to make the body component lightweight and easily formed through aluminum extrusion molding in manufacturing.

### BRIEF DESCRIPTION OF THE DRAWINGS

An example embodiment of the present disclosure will be described hereinafter with reference to the accompanying drawings, in which:

FIG. 1 is a side view illustrating an example placement of a body component according to an embodiment in a vehicle;

FIG. 2A is a cross-sectional view of the body component taken along a line IIA-IIA;

FIG. 2B is a cross-sectional view of the body component taken along a line IIB-IIB;

FIG. 3A is a cross-sectional view of a body component in a first modified example;

FIG. 3B is a cross-sectional view of a body component in a second modified example;

FIG. 4A is a cross-sectional view of a body component in a third modified example;

FIG. 4B is a cross-sectional view of a body component in a fourth modified example;

FIG. 5A is a cross-sectional view of a body component in a fifth modified example;

FIG. 5B is a cross-sectional view of a body component in a sixth modified example; and

FIG. 6 is a cross-sectional view of a body component in a seventh modified example.

### DETAILED DESCRIPTION OF EXEMPLARY EMBODIMENTS

### 1. Embodiment

### 1-1. Configuration

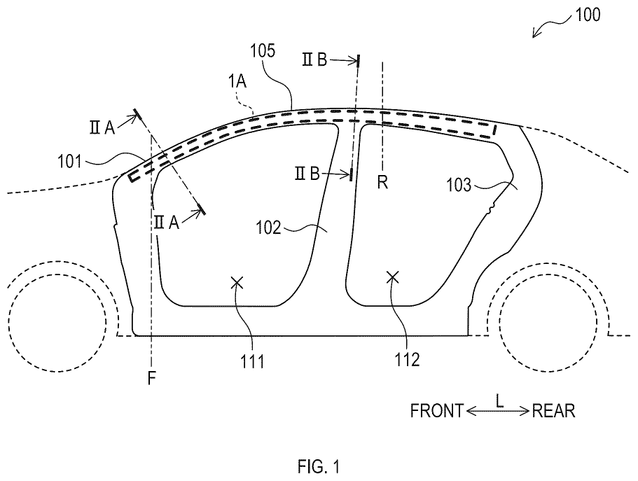

A body component 1A of one mode of the present disclosure is one of components for a vehicle 100. The body component 1A is a part of a lateral surface structure of the vehicle 100. As illustrated in FIG. 1, the body component 1A is an elongated member that is disposed so as to form at least a part of a roof side rail 105. The roof side rail 105 is a structure that is disposed so as to couple upper portions of a front pillar 101, a center pillar 102, and a rear pillar 103 to each other.

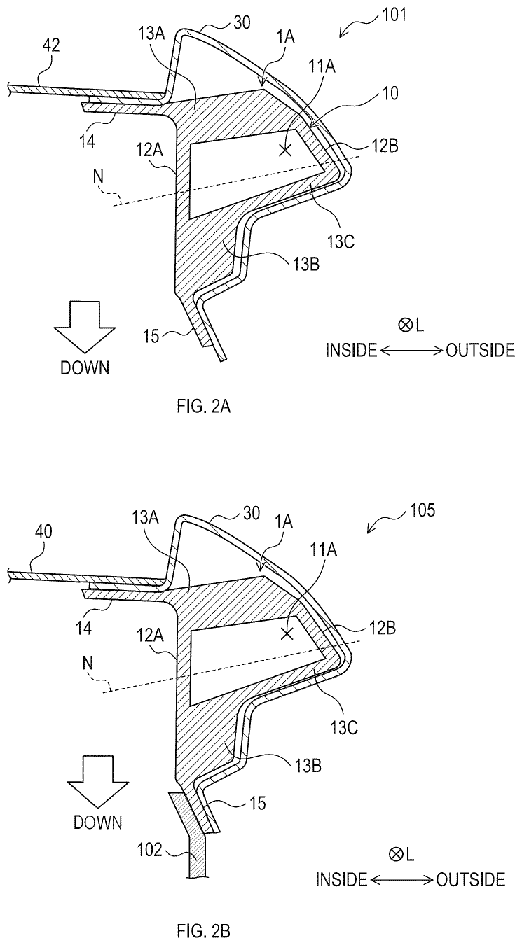

In the configuration of the present embodiment, the roof side rail 105 and the front pillar 101 are integrated, and thus a boundary between the roof side rail 105 and the front pillar 101 is indistinct. In a case where the roof side rail 105 and the front pillar 101 have to be distinguished from each other, they are defined as follows: the roof side rail 105 is a structure that forms a framework above side window glasses adjacent to a driver's seat, a passenger's seat, rear seat, and the like on the rear side of the vehicle 100 with respect to an upper edge of a front windshield 42 (see, FIG. 2A); and the front pillar 101 is a structure that forms a framework extending along a side edge of the front windshield 42 and a front edge of the side window glass adjacent to the driver's seat or the passenger's seat.

The front pillar 101 is disposed in front of a front door opening 111, and the center pillar 102 is disposed in front of a rear door opening 112 and behind the front door opening 111. The front door opening 111 is where a front door is to be disposed, and the rear door opening 112 is where a rear door is to be disposed. The rear pillar 103 is disposed behind the rear door opening 112.

The body component 1A extends along its longitudinal direction L and is disposed so that the longitudinal direction L corresponds to a front-rear direction of the vehicle 100.

The body component 1A is disposed so as to bridge over an upper area of the front door opening 111 and an upper area of the rear door opening 112. For example, a front end of the body component 1A may extend frontward beyond a front edge of the front door opening 111 (a vertical line F in FIG. 1). The front end of the body component 1A may be coupled to a member of the vehicle 100 other than the body component 1A forming the front pillar 101.

Furthermore, for example, a rear end of the body component 1A may extend rearward beyond a rear end of a coupling portion of the body component 1A and the center pillar 102 (a vertical line R in FIG. 1). The rear end of the body component 1A may be coupled to a member forming the rear pillar 103.

The body component 1A is made of a material containing aluminum as a main component. As the material of the body component 1A, any aluminum alloy can be used. For example, the 1000 series aluminum alloys, which are substantially pure aluminum, or the 3000 series aluminum alloys, which are Al—Mn alloys, can be used.

The body component 1A is manufactured through aluminum extrusion molding. The body component 1A manufactured through aluminum extrusion molding has an identical shape in a cross section orthogonal to the longitudinal direction L (hereinafter, simply referred to as “cross section”) at any position in the longitudinal direction L. The body component 1A is formed in a seamless and integrated manner throughout its length along the longitudinal direction L. The body component 1A may be formed by other processing methods such as cutting work.

FIG. 2A is a cross-sectional view of the body component 1A taken along a line IIA-IIA in FIG. 1, and FIG. 2B is a cross-sectional view of the body component 1A taken along a line IIB-IIB in FIG. 1. As illustrated in FIGS. 2A and 2B, the body component 1A comprises an annular portion 10. The body component 1A may comprise at least one fixing portion (for example, a first fixing portion 14 or a second fixing portion 15).

The annular portion 10 comprises passing portions 12A and 12B, and distancing portions 13A, 13B and 13C. In the cross sections of the body component 1A illustrated in FIG. 2A or 2B, an expected bending direction of the body component 1A is substantially a vertical direction. That is, when a front part of the vehicle 100 collides with an object, a bending moment acts on the body component 1A so that a front part of the body component 1A displaces in a vertical direction (for example, downward) with a rear part of the body component 1A being a support point.

A neutral axis N in this situation can be represented by a straight line extending substantially in a horizontal direction. The neutral axis N can be obtained through a simulation of stress distribution and the like using a bending direction and a shape of the body component 1A.

A hollow portion 11A is formed in the annular portion 10. The hollow portion 11A is a space surrounded by a material forming the annular portion 10 and is a portion formed in a hollow (cavity) shape. That is, the annular portion 10 forms a closed hollow cross section. The body component 1A is configured such that the neutral axis N passes through the hollow portion 11A. The passing portions 12A and 12B are portions of the annular portion 10 through which the neutral axis N passes and that are located so as to face each other across the hollow portion 11A. In FIG. 2A and the like, the passing portion 12A is adjacent to the hollow portion 11A and is located on the left of the hollow portion 11A, and the passing portion 12B is adjacent to the hollow portion 11A and is located on the right of the hollow portion 11A.

The distancing portions 13A, 13B and 13C are portions of the annular portion 10 that are relatively more distanced from the neutral axis N than the passing portions 12A and 12B are, and that are located so that the distancing portion 13A faces the distancing portions 13B and 13C across the hollow portion 11A.

In FIG. 2A and the like, the distancing portion 13A is adjacent to the hollow portion 11A and is located above the hollow portion 11A, and the distancing portions 13B and 13C are adjacent to the hollow portion 11A and are located below the hollow portion 11A.

The distancing portion 13B is a portion of the annular portion 10 that is located below the hollow portion 11A and is located on an inside of the vehicle 100, and the distancing portion 13C is a portion of the annular portion 10 that is adjacent to an outside of the distancing portion 13B. Here, in FIG. 2A and the like, a position closer to a center of the vehicle 100 in a width direction of the vehicle 100 (that is, the left side in FIG. 2A and the like) is simply referred to as “inside”, and a position closer to a lateral surface of the vehicle 100 in a width direction of the vehicle 100 (that is, the right side in FIG. 2A and the like) is simply referred to as “outside”.

The thicknesses of the distancing portions 13A and 13B are larger than those of the passing portions 12A and 12B. That is, each of the distancing portions 13A and 13B comprises a thickened portion of the present disclosure. The “thickness” herein refers to a distance between one end surface of a portion of a member adjacent to the hollow portion 11A and the other end surface of the portion of the member opposite to the hollow portion 11A. The “thickness” may be, for example, an average thickness or a maximum thickness of the portion of the member. The thickness of the distancing portion 13C is set to be substantially equal to those of the passing portions 12A and 12B. However, the thickness of the distancing portion 13C may be set larger than those of the passing portions 12A and 12B.

In a portion of the body component 1A where a distance from the neutral axis N is relatively small, a stress generated against the bending moment is small. Therefore, in the body component 1A, the hollow portion 11A is formed along the neutral axis N, and the thicknesses of the passing portions 12A and 12B through which the neutral axis N passes are set to be relatively small. Also, the length of the hollow portion 11A in a direction along the neutral axis N is set to be longer than the length of the hollow portion 11A in a direction orthogonal to the neutral axis N in the cross section.

On the other hand, in a portion of the body component 1A where a distance from the neutral axis N is relatively large, a stress generated against the bending moment and a structural load applied thereto are large. Therefore, in the body component 1A, the thicknesses of the distancing portions 13A and 13B that are distanced from the neutral axis N are set to be relatively large so that the distancing portions 13A and 13B can withstand the stress. That is, each of the distancing portions 13A and 13B comprises the thickened portion of the present disclosure.

The annular portion 10 is formed in a seamless and integrated manner in the cross section orthogonal to the longitudinal direction L of the body component 1A. The outer side of the body component 1A is covered by an outer member 30. The outer member 30 is also referred to as “side member outer”. The outer member 30 is disposed so as to cover the body component 1A to thereby protect the body component 1A from wind, rain, ultraviolet light and the like. Each of the front pillar 101 in the portion illustrated in FIG. 2A and the roof side rail 105 in the portion illustrated in FIG. 2B includes only two members, which are the body component 1A and the outer member 30. That is, the body component 1A is configured to allow reduction in the number of parts of members forming the front pillar 101 and the roof side rail 105.

In the present embodiment, the body component 1A comprises the first fixing portion 14 and the second fixing portion 15. The body component 1A may comprise either the first fixing portion 14 or the second fixing portion 15.

The first fixing portion 14 is a strip-shaped portion that extends towards the inside from the distancing portion 13A located above the hollow portion 11A and along the longitudinal direction L. The first fixing portion 14 is configured such that an upper portion of the first fixing portion 14 is coupled and fixed to the front windshield 42 and a roof member 40 via the outer member 30. The roof member 40 forms a part of a roof of the vehicle 100 on the rear side with respect to the front windshield 42.

The second fixing portion 15 is a strip-shaped portion that extends downwards from the distancing portion 13B located below the hollow portion 11A and along the longitudinal direction L. As illustrated in FIG. 2B, the second fixing portion 15 is configured such that an inner portion of the second fixing portion 15 is coupled and fixed to a member forming the center pillar 102. Forms of coupling between the first fixing portion 14 and the roof member 40, and the second fixing portion 15 and the member forming the center pillar 102 can be freely selected. For example, coupling of each of these portions and members can be achieved with spot welding, adhesives, rivets, bolts and the like.

### 1-2. Effects

According to the embodiment explained above in detail, the following effects can be obtained.

(1a) One mode of the present disclosure is the body component 1A for the vehicle 100. The body component 1A comprises the annular portion 10 including the hollow portion 11A. The hollow portion 11A is formed in the cross section orthogonal to the longitudinal direction L of the body component 1A. The body component 1A is configured such that the neutral axis N of the expected bending direction of the body component 1A passes through the hollow portion 11A in the cross section of the body component 1A.

The passing portions 12A and 12B are portions of the annular portion 10 through which the neutral axis N passes and that are located so as to face each other across the hollow portion 11A. The distancing portions 13A, 13B and 13C are portions of the annular portion 10 that are distanced from the neutral axis N and located so that the distancing portion 13A faces the distancing portions 13B and 13C across the hollow portion 11A. Among the distancing portions 13A, 13B and 13C, the distancing portions 13A and 13B each comprise the thickened portion that is thicker than the passing portions 12A and 12B.

According to such a configuration, the body component 1A comprises the thickened portion in a portion where a stress generated against the expected bending direction acts on more strongly, and is formed relatively thin in a portion in the vicinity of the neutral axis N where the stress is less likely to act on. This enables the body component 1A to withstand the stress and to be lightweight.

(1b) In one mode of the present disclosure, the annular portion 10 is formed in a seamless and integrated manner in the cross section.

According to such a configuration, the annular portion 10 has a seamless structure, which can make the body component 1A withstand a large impact more easily than in a case where the annular portion 10 has a structure with seams. Also, according to such a configuration, the annular portion 10 includes a single member, and thus it is possible to reduce the number of parts of the body component 1A further than in a case where the annular portion 10 includes two or more members.

(1c) In one mode of the present disclosure, the body component 1A further comprises at least one fixing portion (the first fixing portion 14 or the second fixing portion 15) configured to be fixed to a member of the vehicle 100 other than the body component 1A. The first fixing portion 14 and the second fixing portion 15 are seamlessly integrated with the annular portion 10.

According to such a configuration, the annular portion 10 is integrated with the first fixing portion 14 and the second fixing portion 15, and thus it is possible to reduce the number of parts of the body component 1A further than in a case where the annular portion 10 is formed as a body separated from the first fixing portion 14 and the second fixing portion 15.

(1d) In one mode of the present disclosure, the body component 1A is disposed so that the body component 1A forms at least a part of the front pillar 101 and the roof side rail 105, and that the longitudinal direction L of the body component 1A extends along the front-rear direction of the vehicle 100. Also, the body component 1A is formed in a seamless and integrated manner so as to have an identical shape in the cross section at any position in the longitudinal direction L.

According to such a configuration, the body component 1A forms at least a part of the front pillar 101 and the roof side rail 105 in a seamless and integrated manner, and thus it is possible to improve rigidity of a body of the vehicle 100.

(1e) In one mode of the present disclosure, the body component 1A is made of the material containing aluminum as a main component. According to such a configuration, it is possible to make the body component lightweight and easily formed through aluminum extrusion molding in manufacturing.

### 2. Other Embodiments

Although the embodiment of the present disclosure has been described above, the present disclosure should not be limited to the aforementioned embodiment, and may be practiced in various forms.

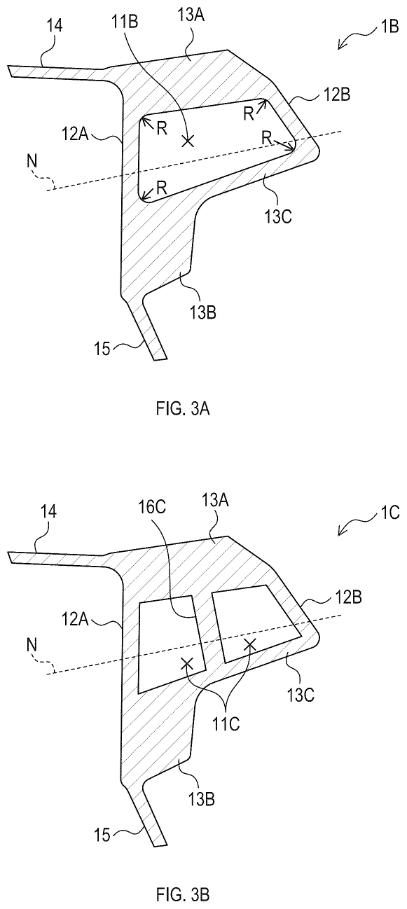

(2a) In the body component 1A of the aforementioned embodiment, a shape of the hollow portion 11A in the cross section is quadrilateral. However, the present disclosure is not limited thereto. For example, as a body component 1B illustrated in FIG. 3A, a hollow portion 11B may be formed. A shape of the hollow portion 11B in the cross section is quadrilateral comprising a corner portion having a roundness R.

Further, for example, as a body component 1C illustrated in FIG. 3B, two or more hollow portions 11C may be formed. The two or more hollow portions 11C may be formed by dividing a center part of the hollow portion 11A of FIG. 2A with a partition 16C. The partition 16C may extends in a direction orthogonal to the neutral axis N, an upper end of the partition 16C may be coupled to the distancing portion 13A, and a lower end of the partition 16C may be coupled to the distancing portion 13B. The partition 16C may be integrated with the annular portion 10.

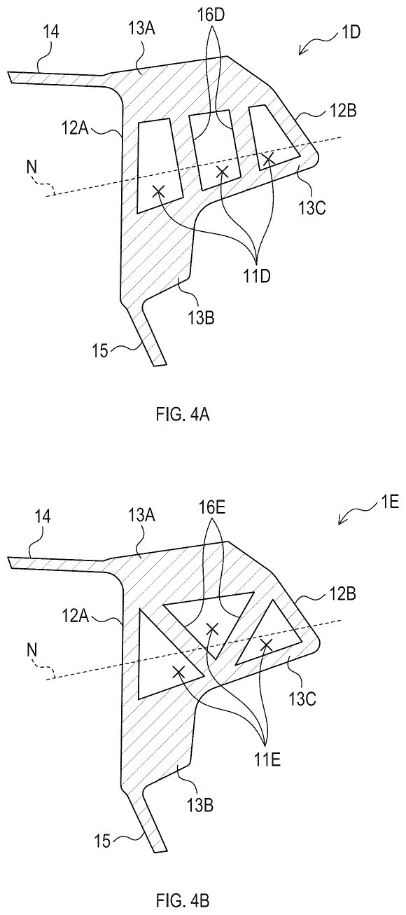

Further, for example, as a body component 1D illustrated in FIG. 4A, three hollow portions 11D may be formed. The three hollow portions 11D may be arranged so as to be partitioned from one another with two partitions 16D. The two partitions 16D may extend in a direction orthogonal to the neutral axis N and may be arranged in parallel to each other.

Further, for example, as a body component 1E illustrated in FIG. 4B, three hollow portions 11E may be formed. The three hollow portions 11E may be arranged so as to be partitioned from one another with two partitions 16E. The two partitions 16E are arranged in a V-shape where a distance between the two partitions 16E increases towards the distancing portion 13A.

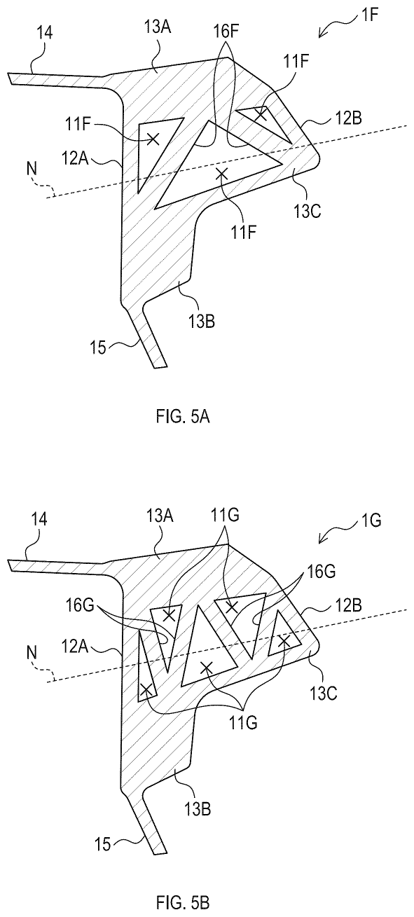

Further, for example, as a body component 1F illustrated in FIG. 5A, three hollow portions 11F may be formed. The three hollow portions 11F may be arranged so as to be partitioned from one another with two partitions 16F. The two partitions 16F are arranged in an inverse V-shape where a distance between the two partitions 16F increases as a distance from the distancing portion 13A increases.

Further, for example, as a body component 1G illustrated in FIG. 5B, four or more hollow portions 11G may be formed. In the example of FIG. 5B, five hollow portions 11G are arranged so as to be partitioned from one another with four partitions 16G. The total length of the hollow portions 11B to 11G in a direction along the neutral axis N may be set longer than the length of the hollow portions 11B to 11G in a direction orthogonal to the neutral axis N in the cross section.

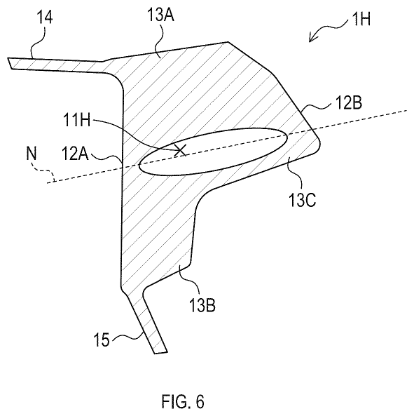

Further, for example, as a body component 1H illustrated in FIG. 6, a hollow portion 11H having an oval or elliptical shape in the cross section may be formed. In this case, it is preferable that a major axis of the oval or elliptical shape coincides with the neutral axis N.

(2b) Two or more functions performed by one element in the aforementioned embodiments may be achieved by two or more elements. One function performed by one element may be achieved by two or more elements. Two or more functions performed by two or more elements may be achieved by one element. One function performed by two or more elements may be achieved by one element. A part of the configuration in the aforementioned embodiments may be omitted. At least a part of the configurations in the aforementioned embodiments may be added to or replaced with another part of the configuration in the aforementioned embodiments. It should be noted that any and all modes included in the technical ideas that are identified by the languages recited in the present disclosure are embodiments of the present disclosure.

(2c) In addition to the body components 1A to 1H described above, the present disclosure can be achieved in various modes such as a system or the vehicle 100 comprising the body components 1A to 1H.

What is claimed is:

1. A body component for a vehicle, the body component comprising:
an annular portion including a hollow portion and formed in an annular shape in a cross section orthogonal to a longitudinal direction of the body component,
wherein the hollow portion is set so that a neutral axis of an expected bending direction of the body component passes through the hollow portion in the cross section, and
wherein the annular portion comprises:
passing portions through which the neutral axis passes and that are located so as to face each other across the hollow portion; and
distancing portions that are distanced from the neutral axis and located so as to face each other across the hollow portion, each of the distancing portions comprising a thickened portion that is thicker than the passing portions.

2. The body component according to claim 1,
wherein the annular portion is formed in a seamless and integrated manner in the cross section.

3. The body component according to claim 1, further comprising:
at least one fixing portion configured to be fixed to a member of the vehicle other than the body component,
wherein the at least one fixing portion is seamlessly integrated with the annular portion.

4. The body component according to claim 1,
wherein the body component is disposed so as to form at least a part of a front pillar and a roof side rail of a vehicle so that the longitudinal direction extends along a front-rear direction of a vehicle, and
wherein the body component is formed in a seamless and integrated manner to have an identical shape in the cross section at any position in the longitudinal direction.

5. The body component according to claim 1,
wherein the body component is made of a material containing aluminum as a main component.

6. The body component according to claim 1,
wherein an outer side of the body component is covered by an outer member.

7. The body component according to claim 6, further comprising:
a first fixing portion configured to be coupled and fixed to a front windshield and a roof member via the outer member in an upper portion of the body component.

8. The body component according to claim 1, further comprising:
a second fixing portion configured to be coupled and fixed to a member of a vehicle forming a center pillar in an inside of the body component.

9. The body component according to claim 1, further comprising:
at least one partition that divides the hollow portion into two or more spaces.

10. The body component according to claim 1,
wherein the hollow portion has an oval or elliptical shape in the cross section, and
wherein a major axis of the oval or elliptical shape coincides with the neutral axis.
